(19) United States
(12) Patent Application Publication
(10) Pub. No.: US 2024/0267071 A1
(43) Pub. Date: Aug. 8, 2024

(54) Universal Smartphone and Tablet Mounts

(71) Applicant: David Sa, Reno, NV (US)

(72) Inventor: David Sa, Reno, NV (US)

(21) Appl. No.: 18/435,061

(22) Filed: Feb. 7, 2024

Related U.S. Application Data
(60) Provisional application No. 63/444,187, filed on Feb. 8, 2023.

(51) Int. Cl. H04B 1/3877; H04M 1/04

(52) U.S. Cl. CPC H04B 1/3877; H04M 1/04

(57) ABSTRACT

Universal mounts for mobile devices such as, but not limited to, smartphones and/or tablets are provided. In one embodiment, a universal mount for a mobile device is provided, the universal mount comprising: a holder that receives a mobile device, the holder comprising a center portion, a first side wall, and a second side wall, wherein the center portion, first side wall, and the second side wall secure the mobile device to the holder; an extension arm that connects to the holder and to a clamp, wherein the extension arm comprises an adjustment controller for adjusting and locking the extension arm; and the clamp for mounting the universal mount to an object, the clamp comprising a first handle and a second handle, a first lip and a second lip, wherein the first and second lips open when pressure is applied to the first and second handles.

### CROSS-REFERENCE TO RELATED APPLICATION

The current application claims priority to U.S. Provisional Patent Application No. 63/444,187, filed on Feb. 8, 2023, the disclosure of which is incorporated herein by reference.

### FIELD OF THE INVENTION

The present disclosure generally relates to mounts and more specifically to universal smartphone and tablet mounts.

### BACKGROUND

Smartphones and tablets (may be referred to collectively as “mobile devices”) are portable computer devices typically with an operating system and a touchscreen display. Although mobile devices may come in various shapes and sizes, the touchscreen displays are typically rectangular in shape and may be operated when oriented vertically or horizontally. Generally, the touchscreen display may be operated by gestures executed by finger or digital pen (i.e., stylus). The touchscreen displays may be used to view media such as, but not limited to, images and videos.

Mobile devices may facilitate the operation of software, access to the internet (including web browsing), and multimedia functionality (e.g., music, video, cameras, and gaming). In addition, mobile devices may include various sensors that can be used by pre-installed and third-party software (e.g., a magnetometer, a proximity sensor, a barometer, a gyroscope, an accelerometer, etc.). Furthermore, mobile devices may support wireless communication protocols (e.g., Bluetooth, Wi-Fi, satellite navigation, etc.).

### SUMMARY OF THE INVENTION

The various embodiments of the present universal smartphone and tablet mounts contain several features, no single one of which is solely responsible for their desirable attributes. Without limiting the scope of the present embodiments, their more prominent features will now be discussed below. After considering this discussion, and particularly after reading the section entitled “Detailed Description,” one will understand how the features of the present embodiments provide the advantages described here.

In a first aspect, a universal mount for a mobile device is provided, the universal mount comprising: a holder that receives a mobile device, the holder comprising a center portion, a first side wall, and a second side wall, wherein the center portion, first side wall, and the second side wall secure the mobile device to the holder; an extension arm that connects to the holder at a first connection point and to a clamp at a second connection point, wherein the extension arm comprises an adjustment controller for adjusting and locking the extension arm; and the clamp for mounting the universal mount to an object, the clamp comprising a first handle and a second handle, a first lip and a second lip, wherein the first and second lips open when pressure is applied to the first and second handles.

In an embodiment of the first aspect, the first side wall and second side wall comprise at least one pad that is in contact with the mobile device when the mobile device is secured to the holder.

In another embodiment of the first aspect, the first side wall has an initial position, and wherein the first side wall slides away from the center portion and locks into at least one predetermined position.

In another embodiment of the first aspect, the second side wall has an initial position, and wherein the second side wall slides away from the center portion when a pulling force is applied and retracts back towards the initial position when the pulling force is removed.

In another embodiment of the first aspect, the center portion comprises a cavity; the first side wall comprises a first stem; and the second side wall comprises a second stem.

In another embodiment of the first aspect, when the first side wall is in the initial position, the first stem is positioned within the cavity of the center portion; and when the first side wall slides away from the center portion, the first stem extends out from the cavity of the center portion.

In another embodiment of the first aspect, the first stem comprises at least one notch corresponding to the at least one predetermined position; and the center portion includes a spring loaded push button that locks the first side wall in the at least one predetermined position.

In another embodiment of the first aspect, when the second side wall is in the initial position, the second stem is positioned within the cavity of the center portion; and when the second side wall is pulled away from the center portion, the second stem extends out from the cavity of the center portion.

In another embodiment of the first aspect, the second side wall comprises a tension spring and wherein: when the pulling force is applied, the tension spring extends allowing the holder to receive the mobile device; and when the pulling force is removed, the tension spring returns the second side wall back towards the initial starting position and thereby exerts a force that secures the mobile device to the holder.

In another embodiment of the first aspect, the extension arm comprises a first section and a second section and wherein the first and second sections are connected at a center joint.

In another embodiment of the first aspect, the center joint connects the first section and the second section of the extension arm using a first set of teeth on first section and a second set of teeth on the second section.

In another embodiment of the first aspect, the adjustment controller includes a first setting that loosens a connection between the first set of teeth and the second set of teeth allowing for adjustment of the extension arm.

In another embodiment of the first aspect, the adjustment controller includes a second setting tightens the connection between the first set of teeth and the second set of teeth thereby locking the extension arm.

In another embodiment of the first aspect, the first setting of the adjustment controller allows for adjustment of the first and second connection points and wherein the second setting of the of the adjustment controller locks the first and second connection points in place.

In another embodiment of the first aspect, the clamp comprises a first angled transition between the first handle to the first lip and a second angled transition between the second handle and the second lip.

In another embodiment of the first aspect, the universal mount further comprises a quick-release device that connects to the clamp, wherein the quick-release device attaches and detaches the extension arm.

In another embodiment of the first aspect, the quick-release device comprises a slot that receives an adapter attached to the extension arm.

In another embodiment of the first aspect, the slot comprises three closed sides and an open side with a gate, wherein the gate opens to receive the adapter attached to the extension arm and closes to lock the adapter into the slot.

In another embodiment of the first aspect, the quick-release device further comprises a gate controller to open and close the gate.

In another embodiment of the first aspect, the gate is spring loaded in a closed position; the gate is angled having a first side that is lower in height relative to a second side; and the gate allows the adapter to slide into the slot and close once the adapter has moved past the gate without activating the gate controller.

### BRIEF DESCRIPTION OF THE DRAWINGS

FIG. 1 is a front perspective view of a universal mount in accordance with certain embodiments of the invention.

FIG. 2A is a left perspective view of a universal mount attached to a tray table in the stowed position in accordance with certain embodiments of the invention.

FIG. 2B is a right perspective view of a universal mount attached to a tray table in the stowed position in accordance with certain embodiments of the invention.

FIG. 2C is a front perspective view of a universal mount attached to a seat back pocket in accordance with certain embodiments of the invention.

FIG. 3A is a front view of a universal mount attached to a tray table in a fully deployed in accordance with certain embodiments of the invention.

FIG. 3B is a left perspective view of a universal mount attached to a tray table in a partially deployed in accordance with certain embodiments of the invention.

FIG. 3C is a front perspective view of a universal mount attached to an armrest in accordance with certain embodiments of the invention.

FIG. 4A is a front view of a holder of a universal mount in accordance with certain embodiments of the invention.

FIG. 4B is a top view of a holder attached to a mobile device in accordance with certain embodiments of the invention.

FIG. 4C is a back view of a holder attached to a mobile device in accordance with certain embodiments of the invention.

FIG. 5 is a side view of a universal mount without an extension in accordance with certain embodiments of the invention.

FIG. 6 is a side view of an extension arm of a universal mount in accordance with certain embodiments of the invention.

FIG. 7 is a side view of another extension arm of a universal mount in accordance with certain embodiments of the invention.

FIG. 8 is a side view of a straight clamp of a universal mount in accordance with certain embodiments of the invention.

FIG. 9 is a side view of an angled clamp of a universal mount in accordance with certain embodiments of the invention.

FIG. 10 is a perspective view of a pull-assist device of a universal mount in accordance with certain embodiments of the invention.

FIG. 11A is a schematic view of a quick-release device of a universal mount in accordance with certain embodiments of the invention.

FIG. 11B is a schematic view of operating a quick-release device in accordance with certain embodiments of the invention.

FIG. 12 is a schematic view of another quick-release device attached to a clamp in accordance with certain embodiments of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

The embodiments of the present universal smartphones and/or tablet mounts (may also be referred to collectively as “universal mounts”) are described below with reference to the figures. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, the present universal mounts are described in the context of mounting to surfaces within a cabin of an airplane. The term “surface” may include any 2D or 3D attachment point. In addition, the use of attachment within an airplane cabin is exemplary and the present universal mounts may be utilized in any environment. For example, the present universal mounts may be used with tables, beach chairs, golf carts/caddies, train seat handles, suitcase handles, airport waiting area seat armrests, inside of motor vehicles, etc. In addition, the universal mounts are described with the user utilizing the mobile device for viewing content. However, the use of viewing content is exemplary and the user may utilize the mobile device in other ways such as, but not limited to, browsing the web, operating the mobile device, taking pictures and/or recording videos, etc. For example, the user may attach the universal mount to various surfaces, attach the mobile device to the universal mount, and take pictures and/or record videos.

Turning now to the drawings, universal mounts for smartphones and tablets in accordance with embodiments of the invention are disclosed. One aspect of the present embodiments includes the realization that current mounts, other than the present embodiments, attachment and use with uneven surfaces, edges, nooks, etc. is often difficult. For example, a user may want to mount a mobile device so that the user may use the device without having to hold the device. However, standard mounts typically attach to flat surfaces (e.g., floor, table edge, etc.) and are not optimized for use with various surfaces (e.g., uneven surfaces, etc.) and in tight spaces. The present embodiments solve these problems by allowing for optimal attachment and use on various surfaces using a claim (e.g., an angled clamp), an extension arm, quick-release device between the clamp and the extension arm, and/or a pull-assist device for operating the clamp.

Another aspect of the present embodiments includes the realization that current mounts, other than the present embodiments, are often difficult to operate with one hand. For example, a user may be holding the mobile device in one hand and thus only has the other hand to operate a mount. However, standard mounts typically are not designed for optimal performance with a single hand. The present embodiments solve these problems by allowing for mounting and/or adjusting of the universal mount with just one hand (e.g., adjusting the extension arm, inserting the gating mechanism of the quick-release device, operation of the clamp, etc.).

As further described below, the universal mounts may include an angled clamp that allows the mount to be attached to various surfaces such as, but not limited to, nooks, edges, even or uneven surfaces, etc. In many embodiments, the universal mounts may also include an extension arm having an adjustment knob that allows for easy adjustment of the mount in tight spaces. In several embodiments, the universal mounts may also include a quick-release device that allows the extension arm (and the holder) to release from the clamp. In a variety of embodiments, the universal mounts may also include a pull-assist device that assists the user in operating the clamp. The present embodiments thus advantageously enable attachment and use of mounts for smartphones and tablets onto various surfaces. The present embodiments provide these advantages and enhancements, as further described below. Universal smartphone and tablet mounts in accordance with embodiments of the invention, is further discussed below.

### Universal Smartphone and Tablet Mounts

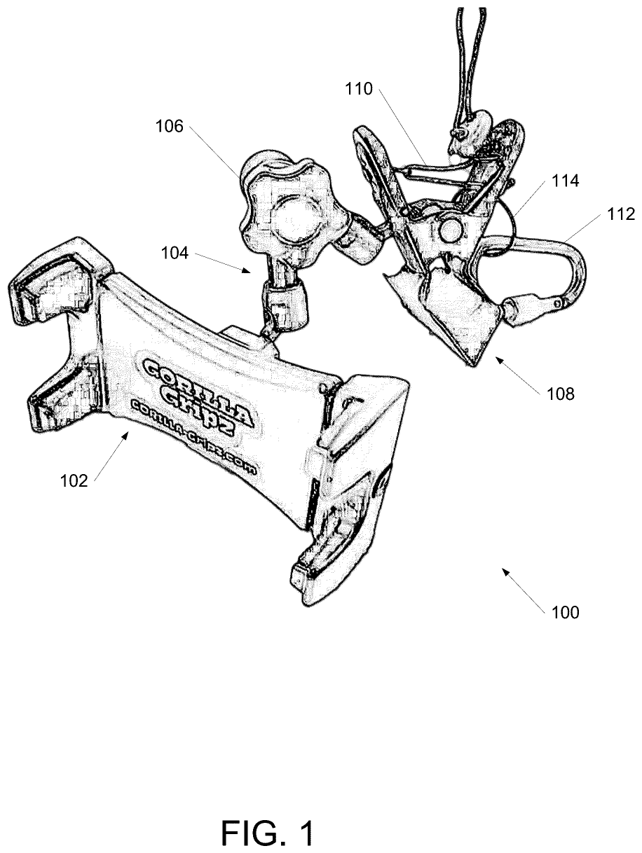

A front perspective view of a universal mount in accordance with certain embodiments of the invention is shown in FIG. 1. The universal mount 100 may include a holder 102 compatible with smartphones and tablets of various sizes, as further described below. The universal mount 100 may also include an extension arm 104 that may be connected with the holder 102. In some embodiments, the extension arm 104 include and may be controlled using an adjustment controller 106 (e.g., an adjustment knob). For example, by rotating the adjustment knob 106 (e.g., rotation of the knob to the left), the extension arm 104 may be adjusted. Then, by rotating the adjustment knob 106 in an opposite direction (e.g., rotation of the knob to the right), the extension arm 104 may be set (e.g., fixed into a position), as further described below. In many embodiments, the universal mount 100 may also include a clamp 108 for mounting the universal mount 100 to various surfaces. In some embodiments, the clamp 108 may be straight or angled, as further described below. In various embodiments, the universal mount 100 may also include a pull-assist device 110 for assisting the user with opening the clamp 108, as further described below. In some embodiments, the universal mount 100 may also include a carabiner 112 and loop 114 to connect various things (e.g., keys, etc.) to the universal mount 100 and/or to connect the universal mount 100 to various equipment (e.g., a bag).

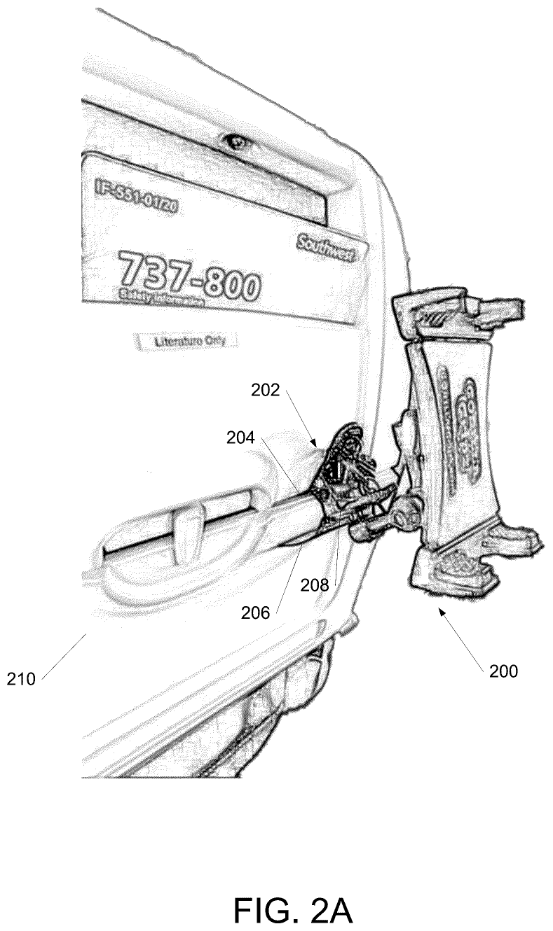

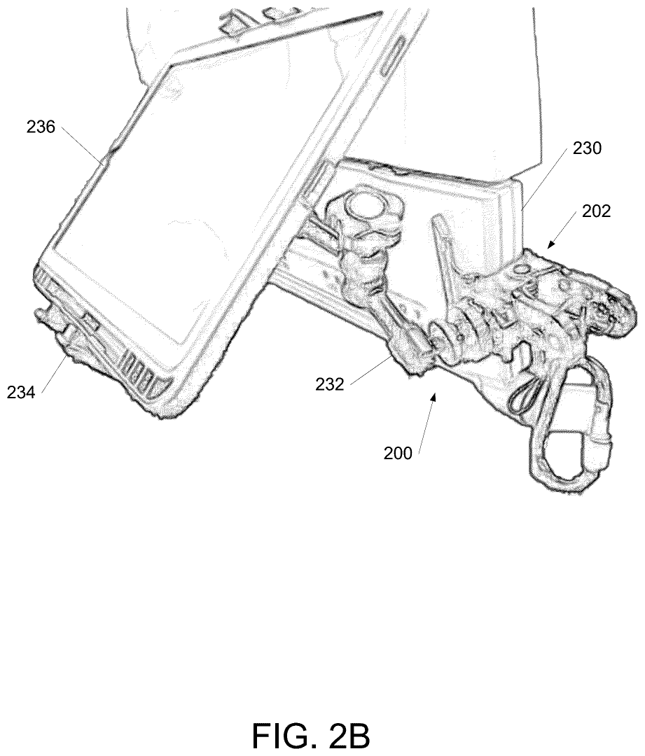

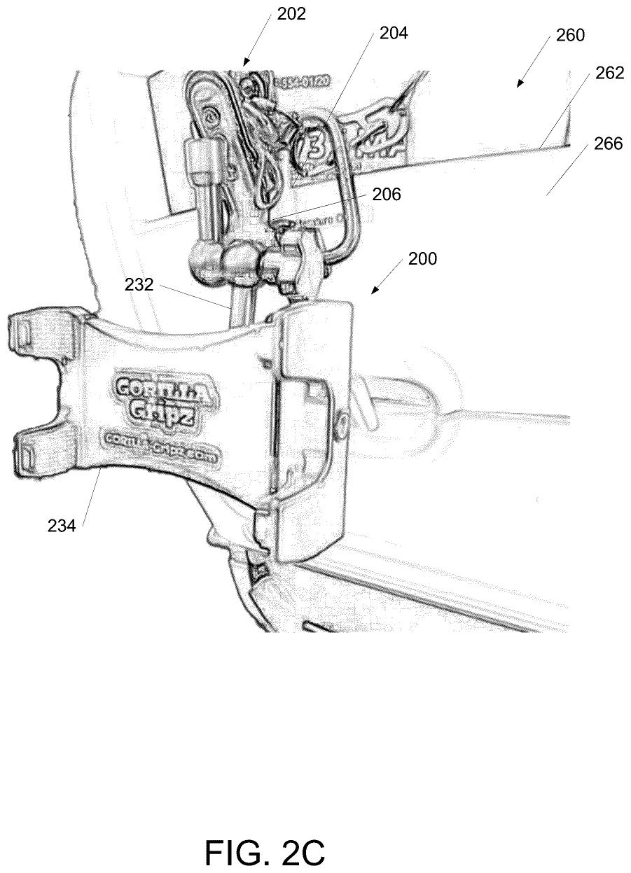

A left perspective view of a universal mount attached to a tray table in the stowed position in accordance with certain embodiments of the invention is shown in FIG. 2A. In various embodiments, the clamp 202 of the universal mount 200 may include a first lip and a second lip 206 that may open when pressure is applied by the user to handles (e.g., squeezed) thereby causing pressure to a torsion spring 208 of the clamp 202 and close when pressure is removed. In many embodiments, pressure may be applied by the user using a single handle.

In reference to FIG. 2A, even when the tray table 210 is stowed (and locked), the clamp 202 may securely attach to the tray table 210. As illustrated in FIG. 2A, the clamp 202 is attached to the tray table 210 slightly off center. By utilizing a first and/or second lip 204, 206, the clamp 202 may be able to fit into tight spaces for attachment. In certain embodiments, the clamp be angled (may also be referred to as an “angled clamp”) may provide further advantages. For example, when the tray table 210 is stowed away, there may not be a flat surface for attachment. In such cases, the use of an angled clamp may provide for a stronger grip and retention of the universal mount. In particular, as the weight of the attached mobile device increases and/or the articulation of the extension arm increases, the attachment of the clamp to a surface may become more critical.

A right perspective view of a universal mount attached to a tray table in the stowed position in accordance with certain embodiments of the invention is shown in FIG. 2B. In comparison to FIG. 2A, the shape and size of the tray table 230 may be different depending on the particular airplane or airline carrier. As illustrated in FIG. 2B, the clamp 202 of the universal mount 200 is attached to the tray table 230 (in a stowed away position) at a side of the tray table 230. In this example, the user is seated in an aisle seat and there may be more free space towards the aisle then the window for the user to attach the mount 200 to the tray table 230. Further, the extension arm 232 (and holder 234) is capable of various positions, allowing the user to situate the mobile device 236 for use, as further described below.

A front perspective view of a universal mount attached to a seat back pocket in accordance with certain embodiments of the invention is shown in FIG. 2C. A seat back pocket 260 may include an opening 262 for inserting and removing reading materials. The clamp 202 of the universal mount 200 may utilize the opening 262 of the seat back pocket 260 to attach the universal mount 200 in front of the user. For example, a first lip 204 of the clamp 202 may insert into the seat back pocket 260 and contact the inner portion of the seat back pocket 260. A second lip 206 of the clamp 200 may contact the outer portion 266 of the seat back pocket 260. The clamp 202 may thus securely attach to the seat back pocket 260 and the extension arm 232 (and the holder 234) may position the mobile device for use, as further described below.

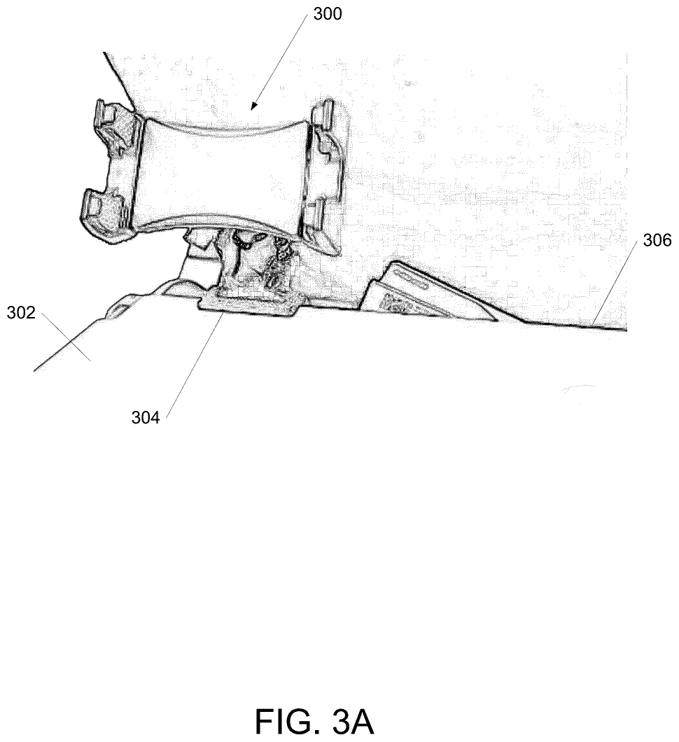

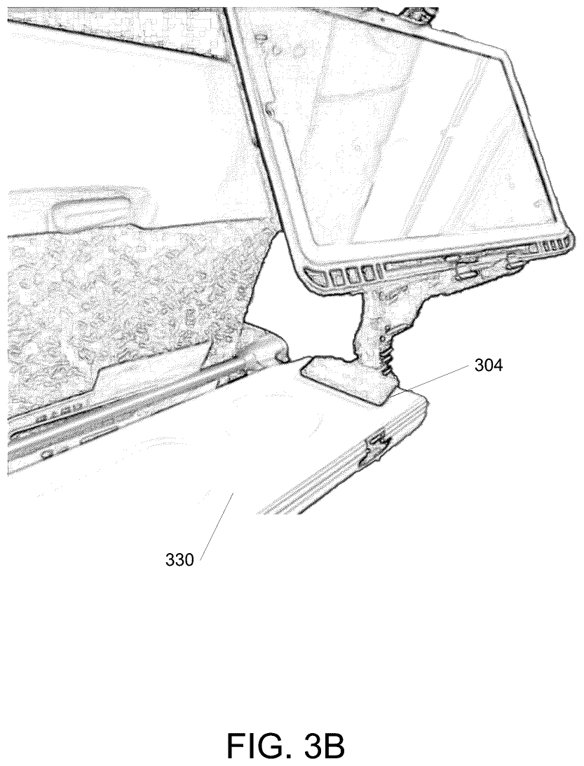

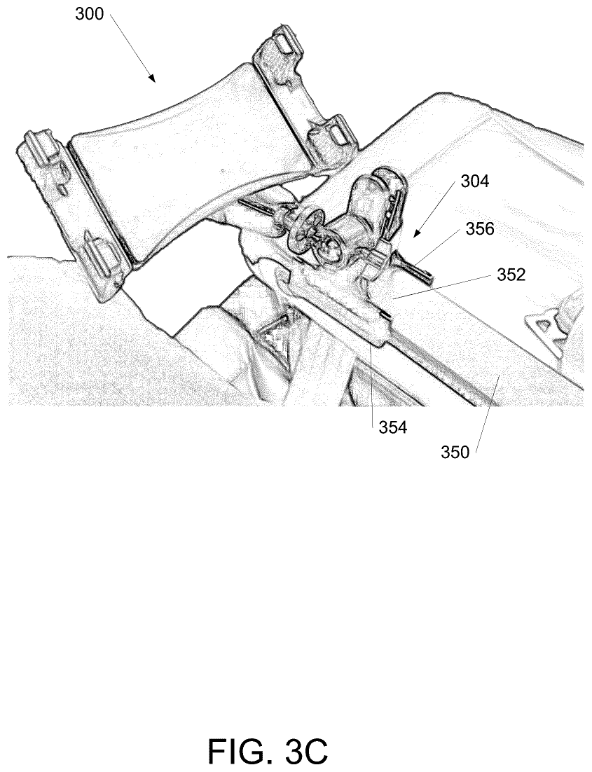

A front view of a universal mount attached to a tray table in a fully deployed in accordance with certain embodiments of the invention is shown in FIG. 3A. A universal mount 300 may attach to all four sides of a fully deployed tray table 302. For example, as illustrated in FIG. 3A, a clamp 304 of the universal mount 300 may attach to a side 306 that is furthest away from the user. In many embodiments, the clamp 304 may fit and be operated in tight spaces such that the universal mount 300 may be securely attached for use by the user.

A left perspective view of a universal mount attached to a tray table in a partially deployed in accordance with certain embodiments of the invention is shown in FIG. 3B. Tray tables 330 may have a partially deployed configuration where the table is deployed but not fully extended. In such configurations, the table 330 may be folded onto itself such that the width of the table 300 is shorter and the thickness greater than when the tray table 300 is fully deployed. As further described below, the clamp 304 may attach to edges of varying thickness. For example, a mouth (i.e., separation of the first and second lips) of the clamp 304 may open wider when the user applies greater force. The clamp 304 may attach to an edge when the mouth of the clamp 304 opens larger than the thickness of the edge and the user releases the pressure, as further described below.

A front perspective view of a universal mount attached to an armrest in accordance with certain embodiments of the invention is shown in FIG. 3C. A clamp 304 of a universal mount 300 may also attach to an armrest 350. As described herein, the clamp 304 may attach to any edge so long as the mouth 352 of the clamp 304 opens wider than the thickness of the edge. As described above, the mouth 352 may be the separation of the first lip 354 and the second lip 356. In some embodiments, the clamp 304 (the mouth 352) may be of varying size depending on the intended application of the universal mount.

Although specific universal mounts are discussed above with respect to FIGS. 1-3C, any of a variety of universal mounts as appropriate to the requirements of a specific application can be used in accordance with embodiments of the invention. Holders for universal mounts in accordance with embodiments of the invention, are discussed further below.

### Holders for Universal Mounts

Universal mounts may include a holder for receiving and attaching a mobile device to the universal mount. In many embodiments, the holder may receive the mobile device in various orientations such as, but not limited to, vertically, horizontally, front facing (i.e., the touchscreen of the mobile device is facing the user), or back facing (i.e., the touchscreen of the mobile device is facing away from the user). Further, after receiving the mobile device, the holder may be rotated and/or angled thereby allowing the user to adjust the mobile device for optimal usage.

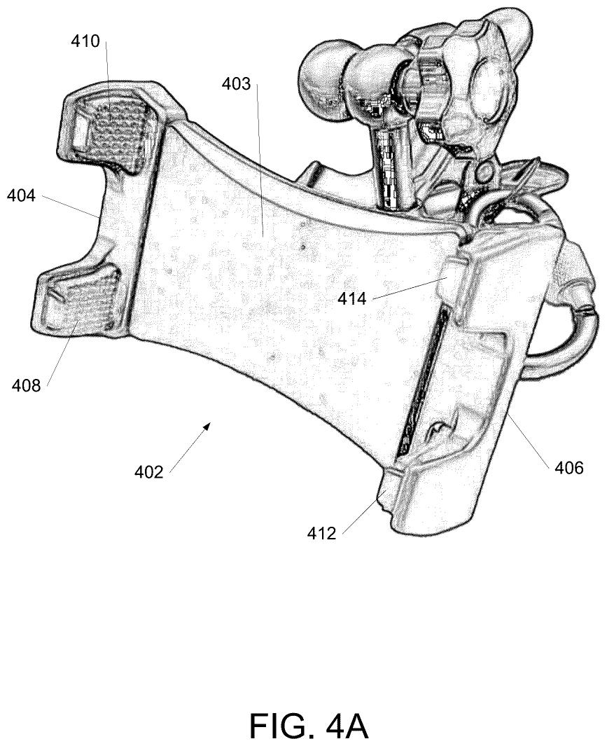

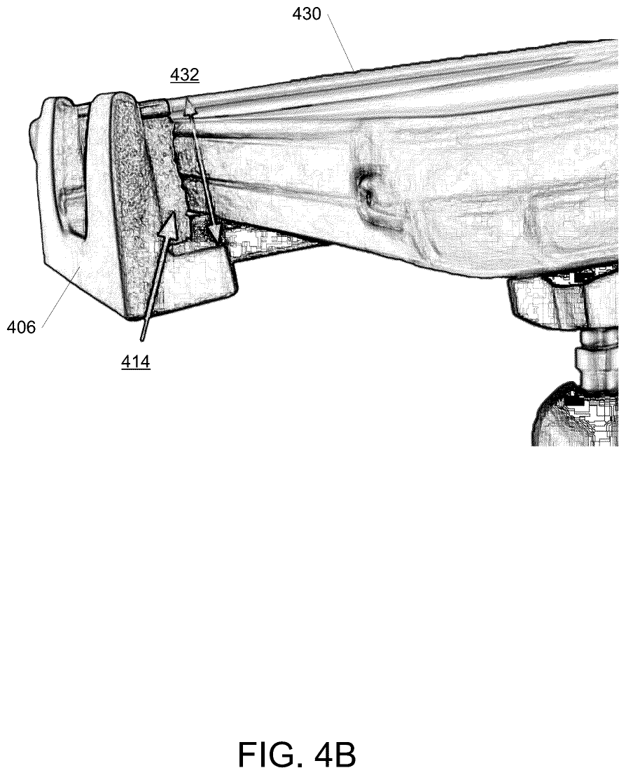

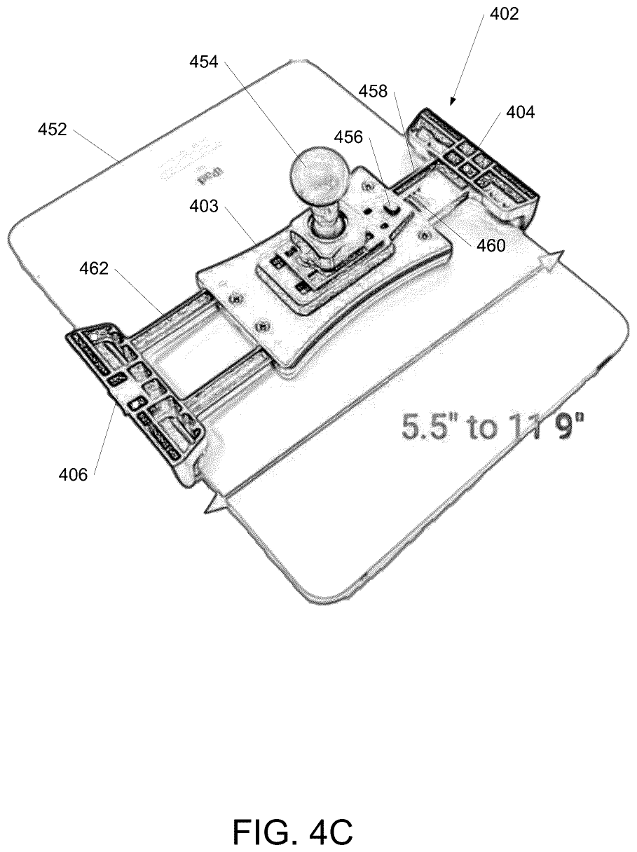

A front view of a holder of a universal mount in accordance with certain embodiments of the invention is shown in FIG. 4A. The holder 402 may include a center portion 403 having cavity [[xxx]], a first side 404 (may also be referred to as a “first side wall”) that may be adjusted and locked to one of at least one predetermined position and a second side 406 (may also be referred to as a “second side wall”) that may be used for securing the mobile device (not illustrated) into the holder 402, as further described below. In many embodiments, the first side 404 may include a first stem 458 (illustrated in FIG. 4C) where the first side 404 may move away and back to the body 403 along the first stem 458. For example, the first stem 458 may be positioned within the cavity of the center portion 403 such that when the first side 404 is closest to the center portion 403 (i.e., an initial position), the first stem 458 is hidden within the cavity of the center portion 403. Further, when the first side 404 slid away (may also be referred to as “pulled away”) from the center portion 403, the first stem 458 extends out from the cavity of the center portion 403. Likewise, the second stem 462 (illustrated in FIG. 4C) may be positioned within the cavity of the center portion 403 such that when the second side 406 is closest to the center portion 403, the second stem 462 is hidden within the cavity of the center portion 403. Further, when the second side 406 pulled away by the user (or pushed by the mobile device) from the center portion 403, the second stem 462 extends out from the cavity of the center portion 403. In various embodiments, the second side 406 may include a tension spring, where pulling the second side away 406 from the center portion 403 may cause the tension spring to extend and allow the holder 402 to receive the mobile device. When the user releases the second side 406, the tension spring may return the second side 406 back to the initial starting position and thereby exert a force that secures the mobile device into the holder 402. The force of the tension spring may be defined by a spring constant and set in various ways as known to one of skill in the art. In various embodiments, the first side 404 that may be adjusted and locked, thereby allowing the holder 402 to expand to various sizes so that the second side 406 may be optimally extended allowing the user to minimize the amount of distance that the second side 406 needs to move away from the first side 404 to receive and secure the mobile device. Further, such a configuration may reduce the amount of force that the tension spring needs to exert in securing the mobile device to the holder 402. In some embodiments, the first side 404 may include one or more pad(s) 408, 410 and the second side 406 may include one or more pad(s) 412, 414. In some embodiments, the pads 408, 410, 412, 414 may further assist in receiving and securing the mobile device by the holder 402. In addition, the pads 408, 410, 412, 414 may prevent the mobile device from damage by reducing pressure applied to the mobile device when secured to the holder 402 and/or by providing a softer surface for contact with the mobile device by the holder 402.

A top view of a holder attached to a mobile device in accordance with certain embodiments of the invention is shown in FIG. 4B. As described above, in some embodiments, the first side 404 and the second side 406 of the holder 402 may include pads (e.g., a soft rubber pad 414 of the second side 406 illustrated) to grip and/or pad the mobile device 430. In some embodiments, the first and second sides 404, 406 may be configured to receive mobile devices 430 with cases and/or covers. For example, the first and second sides 404, 406 may include a width 432 that is wide enough to accommodate protective cases such as, but not limited to, the Otterbox Defender case.

A back view of a holder attached to a mobile device in accordance with certain embodiments of the invention is shown in FIG. 4C. The holder 402 may be configured to receive various sizes of mobile devices 452. For example, in some embodiments, the holder 402 may be compatible with mobile devices between 5.5 inches to 12.1 inches in either length or width. As described above, the first side 404 may include a first stem 458 and the second side 406 may include a second stem 462 that allows the first and second sides 404, 406, respectively, to extend away from the center portion 403. In some embodiments, the first side 404 may be adjusted and locked to one of at least one predetermined position. For example, the first stem 458 may include one or more notches 460. Further, the center portion 403 may include a push button 456 that may be spring loaded that locks the first side 404 in one of the at least one predetermined position (i.e., extension of the first side 404 away from the center portion 403 along the first stem 458) via the one or more notches 460. As further described above, the second side 406 may be pulled away from the center portion 403 (along the second stem 462) causing a tension spring to extend. The user may then release the second side 406 thereby exerting a force that secures the mobile device into the holder 402. For example, when the user releases the second side 406, the second side 406 may be caused to move back towards the center portion 403 along the second stem 462. In various embodiments, the further away the second side 406 is from the center portion 403 (due to the position of mobile device within the holder 402), the stronger the force securing the mobile device to the holder 402, as the tension spring is further extended from the initial starting position (i.e., the position when the second side 406 is closest to the center portion 403).

In reference to FIG. 4C, the holder 402 may be attached to and/or detached from an extension arm of the universal mount, as further described herein. For example, the holder 402 may be attached to and/or detached from the extension arm via a rotating ball joint 454. In some embodiments, the rotating ball joint 454 may be a variety of sizes such as, but not limited to, a 17 mm to 25 mm rotating ball joint.

Although specific holders for universal mounts are discussed above with respect to FIGS. 4A-C, any of a variety of holders as appropriate to the requirements of a specific application can be used in accordance with embodiments of the invention. Universal mounts with and without extension arms in accordance with embodiments of the invention, are discussed further below.

### Universal Mounts with and without Extension Arms

As described above, universal mounts may include a clamp that attaches the universal mount to a surface and a holder that receives a mobile device. In some embodiments, the holder and the clamp may be attached with or without utilizing an extension arm.

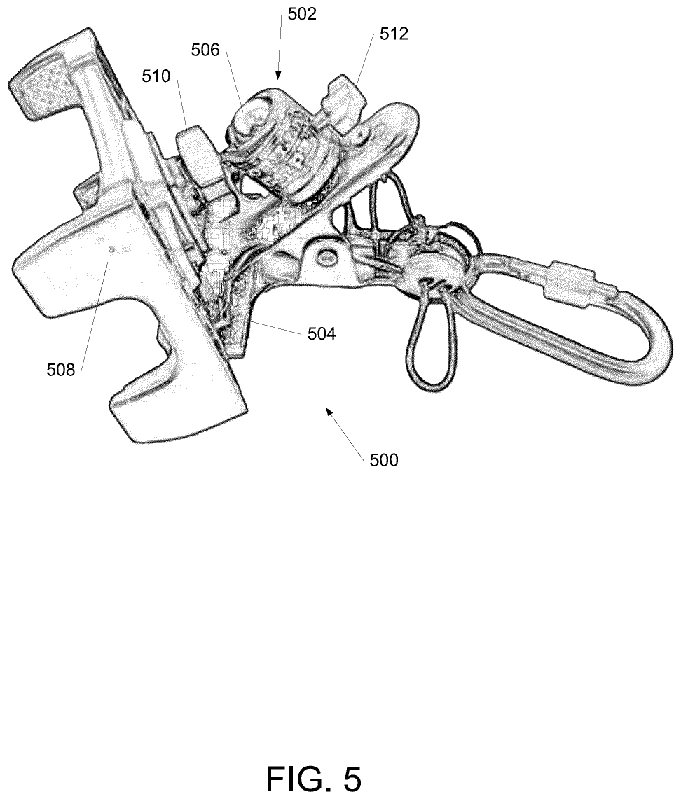

A side view of a universal mount without an extension arm in accordance with certain embodiments of the invention is shown in FIG. 5. The universal mount 500 may include a base rotating ball joint 502 bolted to or otherwise attached to a clamp 504. For example, the base rotating ball joint 502 (e.g., a 20 mm rotating ball joint) may receive a ball 506 (e.g., a 17 mm ball) that extends from the holder 508. In some embodiments, an adapter 510 (e.g., a 25 mm to 17 mm adapter) may be used connect the holder 508 to the base rotating ball joint 502. In some embodiments, the base rotating ball joint 502 may include a base controller (e.g., a base knob 512) that may loosen or tighten the base rotating ball joint's 502 grip on the ball 506 thereby allowing for adjustment of the holder's 510 position.

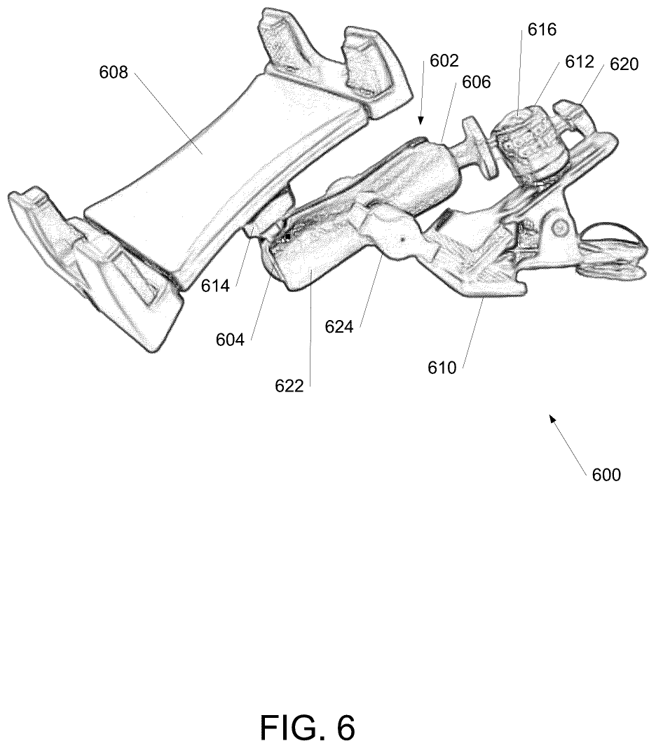

A side view of an extension arm of a universal mount in accordance with certain embodiments of the invention is shown in FIG. 6. In The universal mount 600 may include an extension arm may be a rigid extension arm 602. For example, the rigid extension arm 602 may accept balls on both ends (e.g., 25 mm balls) at a first connection point 604 and a second connection point 606. In many embodiments, the extension arm 602 may connect to the holder 608 at the first connection point 604 and to the clamp 610 (via a base rotating ball joint 612) at the second connection point 606. In some embodiments, an adapter 614 (e.g., a 25 mm to 17 mm) may be used to connect the holder 608 to the first connection point 604 of the extension arm 602. In some embodiments, a ball 616 (e.g., a 25 mm ball) may extend from the base rotating ball joint 612 and connect with the rigid extension arm 602 at the second connection point 606.

In reference to FIG. 6, the extension arm 602 may be adjusted (e.g., rotated) at either the first and/or second connection points 604, 606. For example, the holder 608 and the extension arm 602 may be configured to allow a user to adjust the angle of the mobile device at the first connection point 604. In such examples, a holder 608 may receive a mobile device and the holder 608 may be rotated to adjust the angle of the mobile device. When the mobile device is received in a front facing position (e.g., the touchscreen is facing the user), the user may rotate the holder 608 to adjust the viewing angle of the mobile device. When the mobile device is received in a back facing position (e.g., the touchscreen is facing away from the user), the user may rotate the holder 608 to adjust the camera angle of the mobile device for capturing photos or videos. Further, the extension arm 602 and the clamp 610 may be configured to allow the user to adjust the angle of the extension arm 602 (and thus the holder 608) at the second connection point 606. For example, the user may loosen the grip at the base rotating ball joint 612 using the first adjustment knob 620 to position the extension arm 602 accordingly.

In further reference to FIG. 6, the extension arm 602 may include a elongated section 622 that is rigid and extends the distance between the holder 608 and the clamp 610. The extension arm 602 may also include an adjustment controller (e.g., a an adjustment knob 624) that may loosen or tighten the elongated section's 622 grip on the balls on either side of the extension arm thereby allowing for adjustment. For example, the second adjustment knob 624 may allow a first ball (located inside of the elongated section 622) at the first connection point 604 to rotate within a socket thereby allowing adjustment of the angle of the holder 608 relative to the extension arm. Further, the second adjustment knob 624 may allow a second ball (located inside of the elongated section 622) at the second connection point 606 to rotate within a socket thereby allowing adjustment of the angle of the extension arm 602 relative to the clamp 610. In many embodiments, a single second adjustment knob 624 may be utilized so that the user may be able to control the extension arm 602 using one hand.

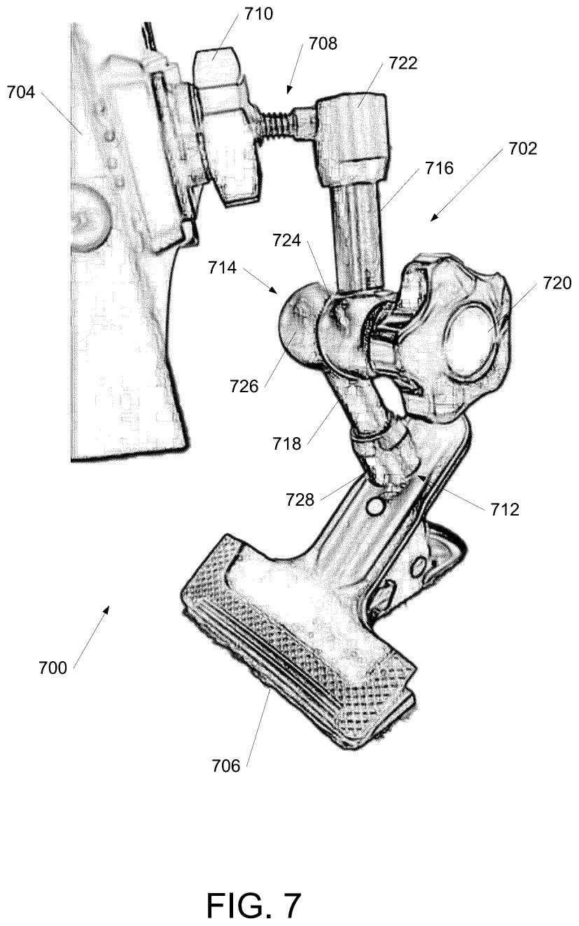

A side view of another extension arm 702 of a universal mount 700 in accordance with certain embodiments of the invention is shown in FIG. 7. As described above, an extension arm 702 may be connected to a holder 704 on one side (e.g., the first connection point) and to a clamp 706 on the opposite side (e.g., at the second connection point). In some embodiments, the extension arm 702 may be connected at the first connection point 708 using an adapter 710 (e.g., a 25 mm to 17 mm), as further described above. However, in some embodiments, the extension arm 702 may be connected at the first connection point directly without the use of an adapter. The extension arm 702 may be connected to the second connection point 712 directly (e.g., fastened to the clamp 706), using a quick-release device (as further described below), using a base rotating ball joint (as further described above), etc.

In many embodiments, an extension arm 702 may have one or more points of adjustability allowing the holder to be pulled forward, pushed back, moved up and down, and/or swiveled. In reference to FIG. 7, the extension arm 702 may be adjusted at the first connection point 708, the second connection point 712, and at center joint 714. The center joint 714 may attach a first section 716 and a second section 718 of the extension arm 702 together using an adjustment controller (e.g., an adjustment knob 720). For example, the first section 716 of the extension arm 702 may be connected to the holder 704 (or adapter 710) at a first end 722 and to the center joint 714 at an opposite second end 724. Further, the second section 718 of the extension arm 720 may be connected to the center joint 714 at a first end 726 and connected to the clamp 706 (or quick-release device or base rotating ball joint) at an opposite second end 728.

In further reference to FIG. 7, the adjustment knob 720 may loosen or tighten the extension arm's 702 grip at the one or more points of attachment (e.g., the first connection point 708, the second connection point 712, or the center joint 714) thereby allowing for adjustment, as further described above. In some embodiments, the center joint 714 may connect the first section 716 and the second section 718 of the extension arm 702 using a first set of teeth on first section and a second set of teeth on the second section so that when the adjustment knob 720 is sufficiently loosened (e.g., placed into a first setting), the first set of teeth on the first section 716 and the second set of teeth on the second section 718 come apart allowing for adjustment. Further, when the adjustment knob 720 is sufficiently tightened (e.g., placed into a second setting), the first and second sets of teeth on the first and second sections 716, 718, respectively, interlock to provide a stronger grip at the center joint 714. In some embodiments, the adjustment knob 720 may control the grip at the first and second connection points 708, 728 utilizing compression springs located within the first section 716 and/or the second section 718 of the extension arm 702.

Although specific universal mounts with or without extension arms are discussed above with respect to FIGS. 5-7, any of a variety of universal mounts with or without extension arms as appropriate to the requirements of a specific application can be used in accordance with embodiments of the invention. Clamps for universal mounts in accordance with embodiments of the invention, are discussed further below.

### Clamps for Universal Mounts

As discussed above, universal mounts may include a clamp for mounting the universal mount to various surfaces. In some embodiments, the clamp may have straight jaws (may be referred to herein as a “straight clamp”). In some embodiments, the clamp may have angled jaws (may also be referred to herein as an “angled clamp”). In addition, the universal mount may also include a pull-assist device for assisting the user with opening the clamp.

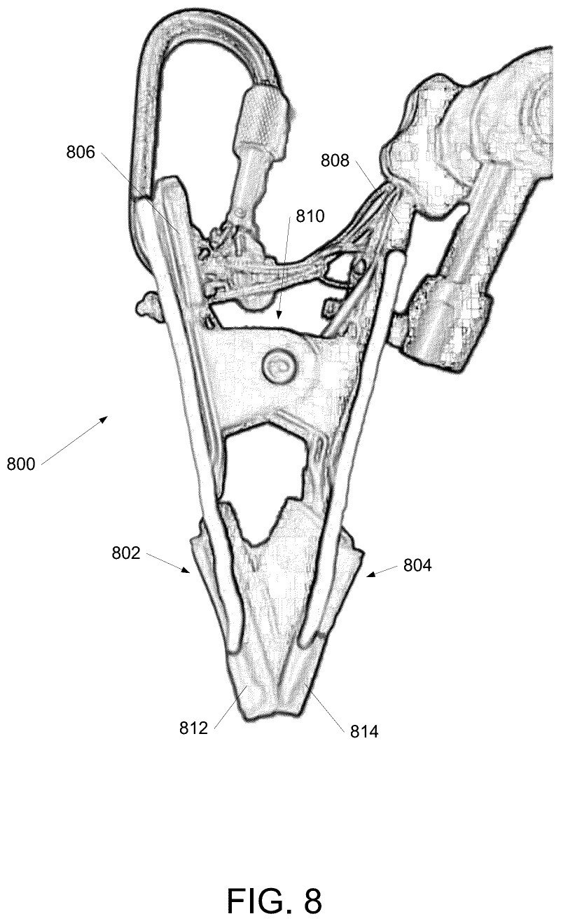

A side view of a straight clamp of a universal mount in accordance with certain embodiments of the invention is shown in FIG. 8. In many embodiments, the straight clamp 800 may be configured as a spring clamp having two straight first and second lips 802, 804, first and second handles 806, 808, and a spring pivot 810 that allows the user to open the first and second lips 802, 804 using the first and second handles 806, 808. For example, a user may squeeze together the first and second handles 806, 808 to open the first and second lips 802, 804 to attach to a surface or object. In some embodiments, the first and second lips 802, 804 may include covers (e.g., a first cover 812 and/or second cover 814) that may be made using a soft plastic, rubber pads, etc. to protect the surface or object that the clamp 800 is attaching to. In some embodiments, the first and second lips 802, 804 may be rectangular in shape to make optimal contact with a surface or an object.

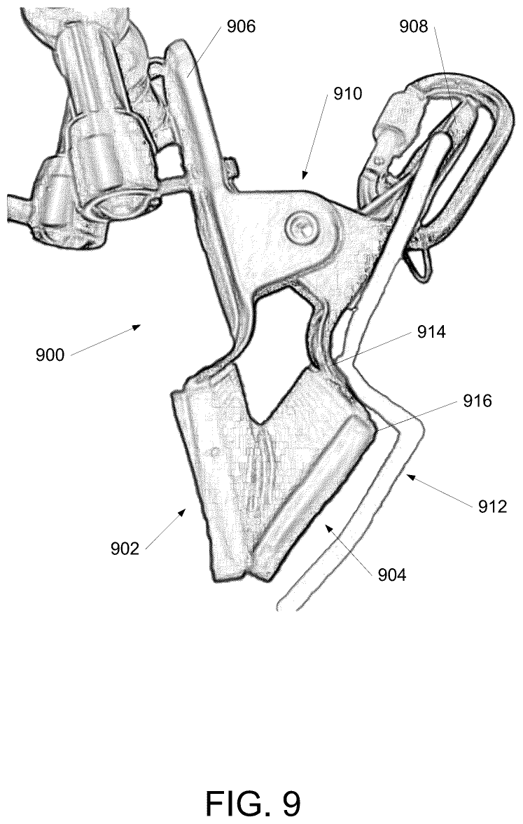

FIG. 9 is a side view of an angled clamp of a universal mount in accordance with certain embodiments of the invention. In many embodiments, the angled clamp 900 include first and second lips 902, 904, first and second handles 906, 908, and a spring pivot 910 that allows the user to open the first lips 902, 904 using the handles 906, 908, as further described above. In various embodiments, the angled claim 900 may allow the universal mount to attach to various surfaces such as, but not limited to, edges, nooks, etc. Further, the angled clamp 900 may include angled transitions between the first handle 906 to the first lip 902 (i.e., a first angled transition) and between the second handle 908 and the second lip 904 (i.e., a second angled transition 912 highlighted). In a variety of embodiments, the angled transitions allow the clamp 900 to attach to thicker surfaces as angled transitions may allow the clamp 900 to have a larger opening when the first and second handles 906, 908 are squeezed together.

In reference to FIG. 9, the angled clamp 900 may include the first and second angled transitions from the first and second handles to the first and second lips, respectively. In some embodiments, the first and second angled transitions may each include a first bend (e.g., first bend 914 of the second angled transition 912 illustrated) that is greater than 90 degrees. In addition, the first and second angled transitions may include a second bend (e.g., second bend 916 of the second angled transition 912 illustrated) that may be equal to 90 degrees. In further embodiments, the first bend may be equal to or less than 90 degrees. In still further embodiments, the second bend may be greater than or less than 90 degrees.

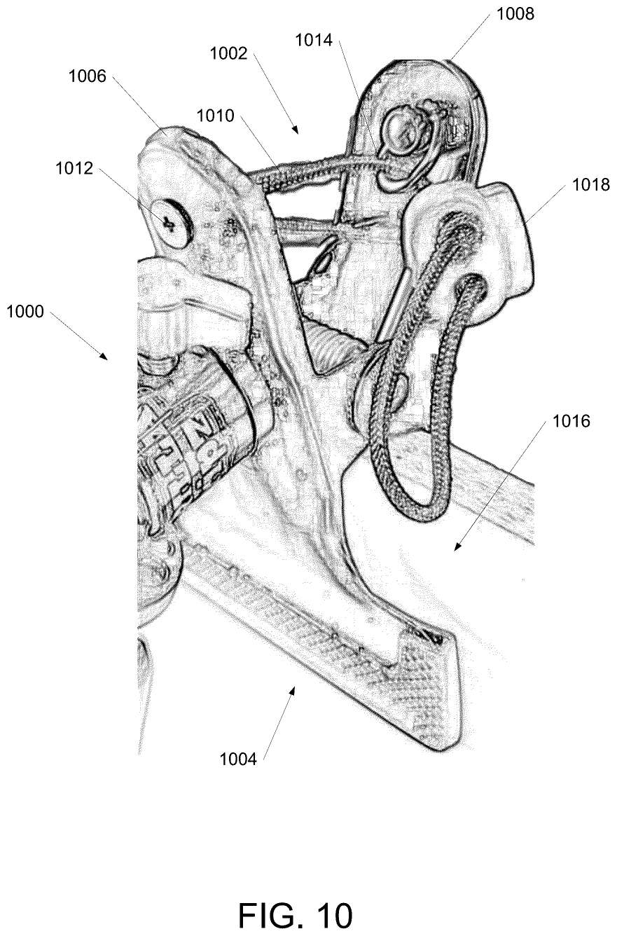

FIG. 10 is a perspective view of a pull-assist device 1002 of a universal mount 1000 in accordance with certain embodiments of the invention. In many embodiments, the pull-assist device 1002 may allow a user to utilize both hands in opening the clamp 1004 of the universal mount 1000. For example, a user may use one hand to squeeze the handles 1006, 1008 from outside of the clamp 1004 and the other hand to pull on the pull-assist device 1002 to pull the handles 1006, 1008 together from the inside of the handles 1006, 1008. In some embodiments, the pull-assist device 1002 may include a cord 1010 (e.g., an elastic cord or rope) that is attached to a first handle 1006. For example, the cord 1010 may be attached to the first handle 1006 by puncturing a hole 1012 in the first handle 1006, threading the cord 1010 through the hole 1012. In some embodiments, the cord may be knotted on the outside (or inside) of the first handle such that the knot attaches the cord 1010 to the first handle 1006. In some embodiments, the cord 1010 may also be attached to second handle 1008 and the first handle 1006 from the inside of the handles 1006, 1008. For example, the second handle 1008 and first handle 1006 may include attachments 1014 (e.g., a loop, a d-ring hang-up loop, hooks, etc.) for the cord 1010 to thread through. Further, the cord 1010 may thread through the loop 1014 on the second handle 1008 and also thread through the loop (not illustrated) on the first handle 1006. The user may thus pull on the cord 1010 to pull the first and second handles 1006, 1008 together in assisting the user with opening the mouth 1016 of the clamp 1004. In some embodiments, the cord 1010 may also include an adjustable end piece 1018 (e.g., a cord lock, cord fastener, plastic stopper, spring clasp, cord toggle, etc.) that allows the user to adjust and/or lock the amount of cord 1010, and thus, the amount of pull or tension that the pull-assist device 1002 applies to the handles 1006, 1008.

Although clamps for universal mounts and pull-assist devices are discussed above with respect to FIGS. 8-10, any of a variety of clamps and pull-assist devices as appropriate to the requirements of a specific application can be used in accordance with embodiments of the invention. Quick-release devices for universal mounts in accordance with embodiments of the invention, are discussed further below.

### Quick-Release Devices for Universal Mounts

Universal mounts may allow for an extension arm to readily release (and attach) to a clamp using a quick-release device. In various embodiments, the quick-release device may be attached to the clamp and the extension arm may readily release and attach to the quick-release device and thereby release and attach to the clamp. In many embodiments, the quick-release device may attach to the clamp using various attachment mechanisms such as, but not limited to, a fastener (e.g., a bolt, etc.) to secure or fasten the quick-release device and clamp together, as further described below.

A schematic view of a quick-release device attached to a clamp in accordance with certain embodiments of the invention. In many embodiments, the quick-release device 1202 may be attached to a clamp 1206. As further described below, the quick-release device 1102 may include a slot 1210 for receiving an adapter 1212 attached to the extension arm 1214. In some embodiments, the extension arm 1214 may also include a lock 1215 (e.g., a screw cap, etc.) that may be utilized to further secure the adapter 1212 within the slot 1210 of the quick-release device 1202, as further describe below.

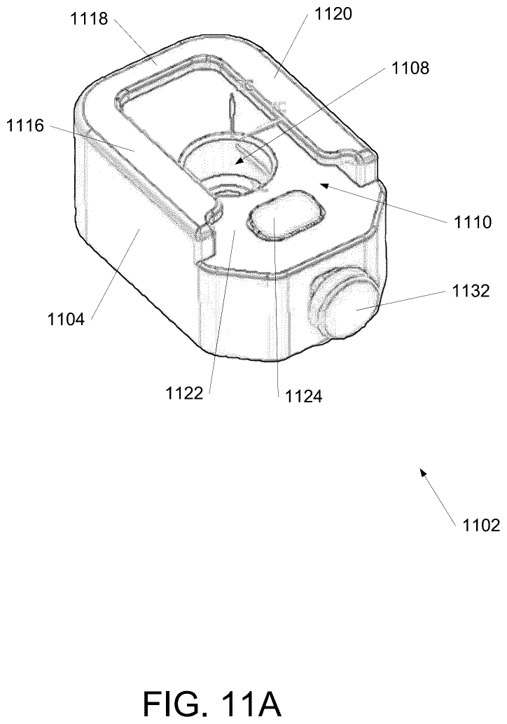

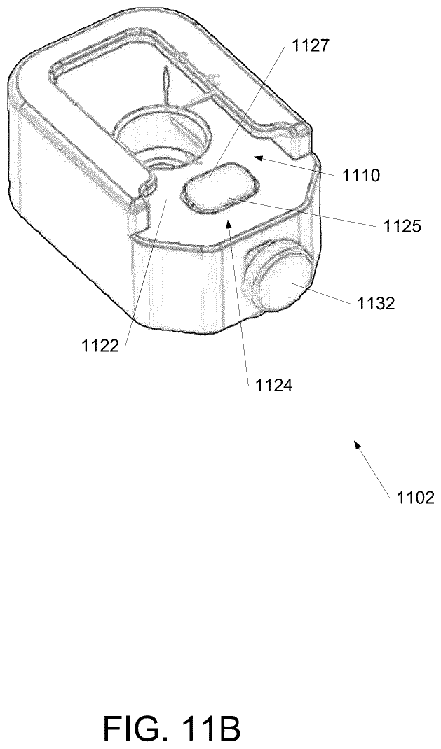

A schematic view of a quick-release device of a universal mount in accordance with certain embodiments of the invention is shown in FIG. 11A. In many embodiments, the quick-release device 1102 may include a body section 1104 that may attach to the clamp. For example, the body section 1104 may include a hole 1108 for receiving a bolt and the clamp may also include a matching hole that may also receive the bolt. In some embodiments, the body section 1104 may be attached to the clamp including, but not limited to, at one of the handles (e.g., either the first handle or the second handle). In some embodiments, the body section 1104 may be attached at either a first bend or a second bend, as further described above. In various embodiments, the body section 1104 may be attached to the clamp using the bolt and fixed in place using a nut. Many types of bolts and hardware nuts may be utilized including bolt types having machine threads. For example, a threaded bolt may screw into a nut to hold or fasten the body section 1104 of the quick-release device 1102 and the clamp together.

In reference to FIG. 11A, the quick-release device 1102 may also include a slot 1110 for receiving an adapter attached to the extension arm. In some embodiments, the slot 1110 may include three closed sides 1116, 1118, 1120 with edges and one open side 1122 with a gate 1124 that may be opened or closed to release or lock the adapter into the slot 1110. In some embodiments, the slot 1110 may include other configurations. For example, the slot may include two closed sides with edges and two open sides with one or more gates that may be opened or closed to release or lock the adapter into the slot.

A schematic view of operating a quick-release device in accordance with certain embodiments of the invention is shown in FIG. 11B. The quick-release device 1102 may include a gate controller 1132 (e.g., a knob, button, etc.) that may be utilized to open and close a gate 1124. In some embodiments, the knob 1132 may be rotated (e.g., 90 degrees) and then pushed in to open the gate 1124. In some embodiments, the knob 1132 may be pushed to open the gate 1124 and released to close the gate 1124. When the gate 1124 is open, the adapter (and thus the extension arm) may be released from the slot 1110 by sliding the adapter along the horizontal axis to slide the adapter out from the slot 1110.

In reference to FIG. 11B, in some embodiments, the gate 1124 may be configured to allow the adapter to slide into the slot 1110 without having to utilize the gate controller 1132. For example, the gate 1124 may be spring-loaded in a closed position. In some embodiments, the gate 1124 may be angled such that a first side 1125 is lower relative to a second side 1127. In some embodiments, when the adapter is inserted into the slot 1110 from the open side 1122, the gate 1124 may open allowing the adapter to slide into the slot 1110, and close once the adapter has moved past the gate 1124. In some embodiments, when the adapter is inserted into the slot 1110 from the open side 1122, the gate 1124 may depress from an initial position allowing the adapter to slide into the slot 1110, and close by pushing back up to the initial position once the adapter has moved past the gate 1124. Thus, inserting the extension arm into the quick-release device 1102 may be performed using one hand and without the need to press or activate the gate controller 1132. In some embodiments, the relative angle of the first side 1125 and the second side 1127 may further assist and/or secure the adapter within the slot 1110. In some embodiments, the extension arm may also include a lock (e.g., a screw cap, etc.) that may be utilized to further secure the adapter within the slot 1110, as further described above.

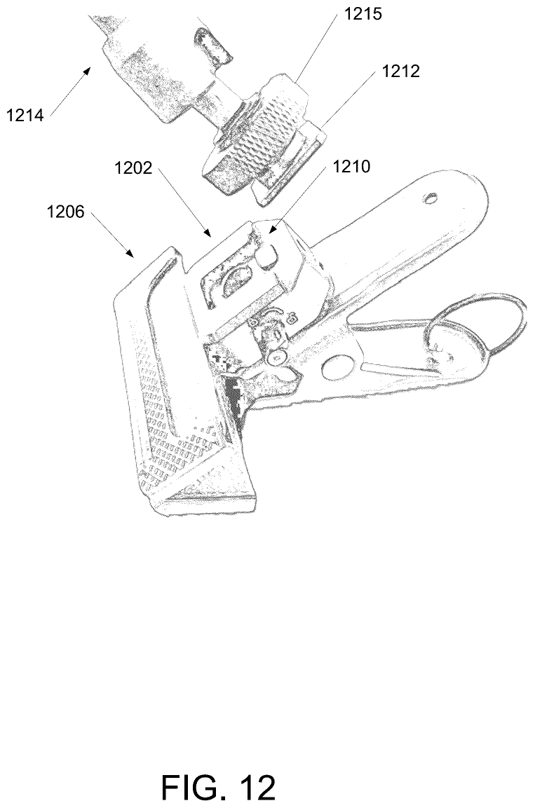

Although quick-release devices in accordance with embodiments of the invention are discussed with respect to FIGS. 11A-12, any of a variety of quick-release devices as appropriate to the requirements of a specific application can be used in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A universal mount for a mobile device, the universal mount comprising:
a holder that receives a mobile device, the holder comprising a center portion, a first side wall, and a second side wall, wherein the center portion, first side wall, and the second side wall secure the mobile device to the holder;
an extension arm that connects to the holder at a first connection point and to a clamp at a second connection point, wherein the extension arm comprises an adjustment controller for adjusting and locking the extension arm; and
the clamp for mounting the universal mount to an object, the clamp comprising a first handle and a second handle, a first lip and a second lip, wherein the first and second lips open when pressure is applied to the first and second handles.

2. The universal mount of claim 1, wherein the first side wall and second side wall comprise at least one pad that is in contact with the mobile device when the mobile device is secured to the holder.

3. The universal mount of claim 1, wherein the first side wall has an initial position, and wherein the first side wall slides away from the center portion and locks into at least one predetermined position.

4. The universal mount of claim 3, wherein the second side wall has an initial position, and wherein the second side wall slides away from the center portion when a pulling force is applied and retracts back towards the initial position when the pulling force is removed.

5. The universal mount of claim 4, wherein:
the center portion comprises a cavity;
the first side wall comprises a first stem; and
the second side wall comprises a second stem.

6. The universal mount of claim 5, wherein:
when the first side wall is in the initial position, the first stem is positioned within the cavity of the center portion; and
when the first side wall slides away from the center portion, the first stem extends out from the cavity of the center portion.

7. The universal mount of claim 6, wherein:
the first stem comprises at least one notch corresponding to the at least one predetermined position; and
the center portion includes a spring loaded push button that locks the first side wall in the at least one predetermined position.

8. The universal mount of claim 5, wherein:
when the second side wall is in the initial position, the second stem is positioned within the cavity of the center portion; and
when the second side wall is pulled away from the center portion, the second stem extends out from the cavity of the center portion.

9. The universal mount of claim 8, wherein the second side wall comprises a tension spring and wherein:
when the pulling force is applied, the tension spring extends allowing the holder to receive the mobile device; and
when the pulling force is removed, the tension spring returns the second side wall back towards the initial starting position and thereby exerts a force that secures the mobile device to the holder.

10. The universal mount of claim 1, wherein the extension arm comprises a first section and a second section and wherein the first and second sections are connected at a center joint.

11. The universal mount of claim 10, wherein the center joint connects the first section and the second section of the extension arm using a first set of teeth on first section and a second set of teeth on the second section.

12. The universal mount of claim 11, wherein the adjustment controller includes a first setting that loosens a connection between the first set of teeth and the second set of teeth allowing for adjustment of the extension arm.

13. The universal mount of claim 12, wherein the adjustment controller includes a second setting tightens the connection between the first set of teeth and the second set of teeth thereby locking the extension arm.

14. The universal mount of claim 13, wherein the first setting of the adjustment controller allows for adjustment of the first and second connection points and wherein the second setting of the of the adjustment controller locks the first and second connection points in place.

15. The universal mount of claim 1, wherein the clamp comprises a first angled transition between the first handle to the first lip and a second angled transition between the second handle and the second lip.

16. The universal mount of claim 1 further comprising a quick-release device that connects to the clamp, wherein the quick-release device attaches and detaches the extension arm.

17. The universal mount of claim 16, wherein the quick-release device comprises a slot that receives an adapter attached to the extension arm.

18. The universal mount of claim 17, wherein the slot comprises three closed sides and an open side with a gate, wherein the gate opens to receive the adapter attached to the extension arm and closes to lock the adapter into the slot.

19. The universal mount of claim 18, wherein the quick-release device further comprises a gate controller to open and close the gate.

20. The universal mount of claim 19, wherein:
the gate is spring loaded in a closed position;
the gate is angled having a first side that is lower in height relative to a second side; and
the gate allows the adapter to slide into the slot and close once the adapter has moved past the gate without activating the gate controller.
